(19) United States
(12) Patent Application Publication
(10) Pub. No.: US 2006/0133308 A1
(43) Pub. Date: Jun. 22, 2006

(54) Active set management for packet data services in a mixed capability wireless communication network

(75) Inventor: Seema Madan, San Diego, CA (US)

Correspondence Address: COATS & BENNETT, PLLC, P O BOX 5, RALEIGH, NC, 27602, US

(73) Assignee: Telefonatiebolaget L M Ericsson

(21) Appl. No.: 11/018,361

(22) Filed: Dec. 21, 2004

(51) Int. Cl. H04L 1/00; H04J 1/16; H04J 3/14; H04L 12/26

(52) U.S. Cl. 370/328; 370/252

(57) ABSTRACT

A wireless communication network includes radio base stations of a first type that support dedicated channel packet data service and radio base stations of a second type that additionally support shared channel packet data service. A base station controller evaluates pilot signal strength reports to determine whether to serve a given mobile station on a shared packet data channel or on a dedicated packet data channel. Evaluation may comprise determining whether any pilot signals in the report correspond to radio base stations of the second type. If so, and if one or more service criteria are met, the controller serves the mobile station on a shared packet data channel, and otherwise serves it on a dedicated packet data channel. The controller may control or otherwise limit the mobile station's active set based on identifying pilot signals in the report that correspond to radio base stations of the second type.

### BACKGROUND OF THE INVENTION

The present invention generally relates to wireless communication networks, and particularly relates to providing packet data services in networks having radio base stations of different packet data service capabilities.

Commercial communication networks, such as the wireless communication networks provided by the various cellular communication service providers, change over time in the ongoing quest to provide ever faster data services. In some instances, the changes are revolutionary, such as the change from analog to digital services. In other instances, the changes are evolutionary, such as the addition of newer and faster channel types to preexisting digital networks.

The addition of a high-speed, shared forward link packet data channel in the 1× Evolution Data and Voice (1×EV-DV) extensions to the cdma2000-based networks stands as one example of the latter case. More particularly, the 1×EV-DV standards add a time-multiplexed packet data channel to the forward link, referred to as the “Forward Packet Data Channel” or F-PDCH. Packet data rates on the F-PDCH generally are much higher than achievable using the Forward Fundamental Channel (F-FCH) and Forward Supplemental Channel (F-SCH) combination available in the first generation of cdma2000, referred to as 1× Radio Transmission Technology (1×RTT).

1×RTT radio base stations provide legacy circuit-switched services and low-rate packet data to individual users using dedicated F-FCHs, and support higher packet data rates to specific users by assigning dedicated F-SCHs to individual ones of those users as needed. The F-SCHs are configurable for data rates that are multiples of the F-FCH data rate, such as 2×,4×, 8×, and so on. However, the higher data rates generally require higher transmission powers, plus the higher data rates use increasing-length Walsh codes. Thus, F-SCH service represents potentially significant use of the transmit power and spreading code resources available at a given radio base station.

1×EV-DV radio base stations are backwards compatible, offering F-FCH and F-SCH services. However, by providing F-PDCH services, 1×EV-DV radio base stations offer higher packet data rates at greater efficiency. Typically, a 1×EV-DV radio base station transmits per-sector F-PDCHs using whatever transmit power and (Walsh) code resources are leftover in each sector after allocating power and spreading code resources to all of the dedicated broadcast, control, and data channels required at any given instant. A scheduling controller time-multiplexes packet data onto the F-PDCH for the individual users sharing the channel, with each user generally being served at the highest possible data rate supported by that user's radio conditions and the F-PDCH resource availability. With F-PDCH service, more users are served at higher data rates than would be achievable with F-FCH/F-SCH packet data service.

Despite these service advantages, a given network operator may not fully deploy 1×EV-DV services because of cost or other reasons. For example, a given network operator might upgrade to 1×EV-DV radio base stations just in the areas where there is a significant economic advantage to doing so, such as crowded urban areas where there is a higher concentration of users willing to pay for higher-rate packet data services. For whatever reasons, it is not uncommon for a given cdma2000 network to include a mix of 1×RTT radio base stations and 1×EV-DV radio base stations. In such mixed-capability environments, only some of the radio sectors offer shared channel packet data services via the F-PDCH, with the remaining sectors offering only dedicated channel packet data services via the F-FCH/F-SCH. The same mixed-capability scenarios apply to other network types as well, such as in networks based on the Wideband CDMA standards, wherein High Speed Downlink Packet Access (HSDPA) channels may not be available from all radio base stations.

Thus, evolving wireless communication networks may offer shared channel, high-rate packet data services from a only subset of radio base stations in a given geographic area and dedicated channel, lower-rate packet data services from all of them. A challenge arises, then, in managing call setup and call handover among and between the various radio stations for packet data calls that are preferentially carried on the shared packet data channel because of its higher data rates and more efficient use of network resources.

### SUMMARY OF THE INVENTION

The present invention comprises a method of managing packet data service to a mobile station in a wireless communication network comprising one or more radio base stations of a first type that support dedicated packet data channel service and one or more radio base stations of a second type that additionally support shared packet data channel service. Selectively serving a given mobile station using a shared packet data channel or using a dedicated packet data channel depends on the availabilities of the different channel types at the radio base stations available for serving the mobile station. The selection of channel type also may depend on additional considerations, such as radio sector congestion, and any limitations on the types of channels that can be handed off between radio base stations or between base station control boundaries.

In one embodiment, then, the present invention comprises a method of selectively serving a given mobile station on a shared channel or a dedicated channel based on receiving and evaluating one or more signal quality reports from the mobile station, and serving the mobile station on a shared packet data channel if the one or more signal quality reports indicate the availability of satisfactory shared packet data channel service to the mobile station, and otherwise serving the mobile station on a dedicated packet data channel. In this context, the term “satisfactory shared packet data channel service” connotes the availability of a radio link to the mobile station of sufficient signal strength and additionally may connote the satisfaction of one or more additional metrics, such as acceptably low congestion levels associated with the radio base station(s) to be used for providing the shared channel service to the mobile station.

Receiving and evaluating one or more signal quality reports from the mobile station comprises receiving one or more pilot strength measurement reports from the mobile station. A base station controller, for example, may receive a pilot strength measurement report for a complete active set of the mobile station. The controller may then determine whether any pilot signal in the complete active set corresponds to a radio base station having shared channel capabilities and meets one or more defined service criteria and, if so, serve the mobile station on a shared packet data channel and otherwise serve the mobile station on a dedicated packet data channel. In cdma2000-based networks, channel type selection may be between the use of a dedicated F-SCH and a shared F-PDCH. Other network types may involve similar dedicated/shared channel selection.

In one or more embodiments, channel type selection processing is based on managing the active set(s) of a given mobile station. In general, a given mobile station's “complete active set” corresponds to those radio base stations that can provide radio links with the mobile station at a defined signal strength. If one or more of the radio base stations is capable of providing shared packet data channel service to the mobile station and if one or more other optional service criteria are met, the mobile station is served on the shared packet data channel.

In so doing, the network may define a reduced active set of radio base stations, corresponding to those radio base stations in the complete active set that have shared packet data channel capability. The complete active set still may be used for circuit-switched and low-rate data services, meaning that the mobile station operates with two active sets, one for circuit-switched and low rate data and another set for high-rate, shared-channel packet data services. In another embodiment, the network limits the active set used for circuit-switched and low-rate data to the same radio base stations comprising the reduced active set. In such embodiments, then, the mobile station operates with a single, limited active set for all types of services.

In either case, the mobile station's packet data service can be changed from shared channel service to dedicated channel service, or changed from dedicated channel service to shared channel service, as needed. Changing signal quality reports and/or changing network conditions provide triggers for changing from one service type to the other, and base station controllers can be configured to evaluate such information on an ongoing basis as part of channel type selection processing and active set management.

### BRIEF DESCRIPTION OF THE DRAWINGS

FIG. 1 is a block diagram of a wireless communication network, which may comprise a cdma2000-based cellular communication network.

FIG. 2 is a block diagram of radio base stations that may be used in the network of FIG. 1.

FIG. 3 is a diagram of complete active sets, reduced active sets, and limited active sets used in various embodiments to determine service/channel types used in providing packet data service to a mobile station.

FIG. 4 is a logic flow diagram illustrating processing logic to select between shared and dedicated channel service for providing packet data service to a given mobile station.

FIG. 5 is a logic flow diagram illustrating processing logic to select between shared and dedicated channel service for a given mobile station based on the use of reduced active set processing.

FIG. 6 is a logic flow diagram illustrating processing logic to select between shared and dedicated channel service for a given mobile station based on the use of limited active set processing.

FIG. 7 is a block diagram illustrating one embodiment of a base station controller configured to select between shared and dedicated channel service for providing packet data service to a given mobile station.

### DETAILED DESCRIPTION OF THE INVENTION

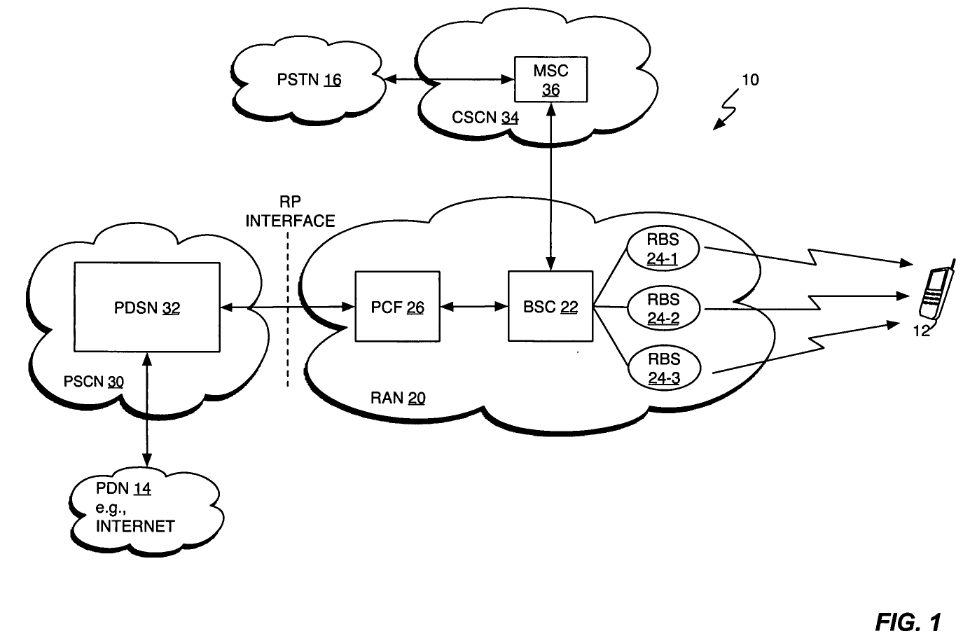

FIG. 1 is a diagram of a wireless communication network 10 that communicatively couples mobile stations 12 to one or more external networks, such as Public Data Networks (PDNs) 14 and the Public Switched Telephone Network (PSTN) 16. PDN(s) 14 comprise the Internet and/or other packet-switched data networks, and mobile terminals 12 can be configured to run a variety of packet data applications, such as Web browsing, email, file transfers, etc. By way of non-limiting examples, the network 10 is configured as a cdma2000-based wireless communication network offering, or as a Wideband CDMA (W-CDMA) based wireless communication network.

The network 10 comprises a Radio Access Network (RAN) 20 that includes one or more Base Station Controllers (BSCs) 22, Radio Base Stations (RBSs) 24, and Packet Control Functions (PCFs) 26. For simplicity, one BSC 22 and a corresponding PCF 26 are illustrated, with three RBSs, denoted as 24-1, 24-2, and 24-3, shown operating under the illustrated BSC's control.

The RAN 20 communicatively couples to the PDN(s) 14 through a Radio-Packet (RP) interface to a Packet Switched Core Network (PSCN) 30 that includes a Packet Data Serving Node (PDSN) 32 and that may include other entities not illustrated. Similarly, the RAN 20 communicatively couples to the PSTN 16 through a Circuit Switched Core Network (CSCN) 34 that includes a Mobile Switching Center (MSC) 36 and that may include other entities not illustrated.

Each RBS 24 provides service coverage in one or more radio sectors and, depending on reception conditions, a given mobile station 12 may receive radio signals from more than one RBS 24. However, the RBSs 24 of the network 10 do not all offer the same packet data service capabilities. In general terms, the network comprises one or more RBSs 24 of one type that support dedicated packet data channel service and one or more RBSs of a second type that additionally support shared packet data channel service.

In a cdma2000 embodiment, a first type of RBS 24 in the network 10 supports packet data services using Fundamental Channels (FCHs) and extends that support to higher data rates using Supplemental Channels (SCHs), while a second type of RBS 24 supports packet data services using FCHs and SCHs and, additionally, using a shared Forward Packet Data Channel (F-PDCH). Packet data service via the F-PDCH generally is preferred to packet data service via one or more Forward SCHs (F-SCHs), because the F-PDCH offers higher data rates and more efficient usage of network resources, such as transmit power and spreading codes.

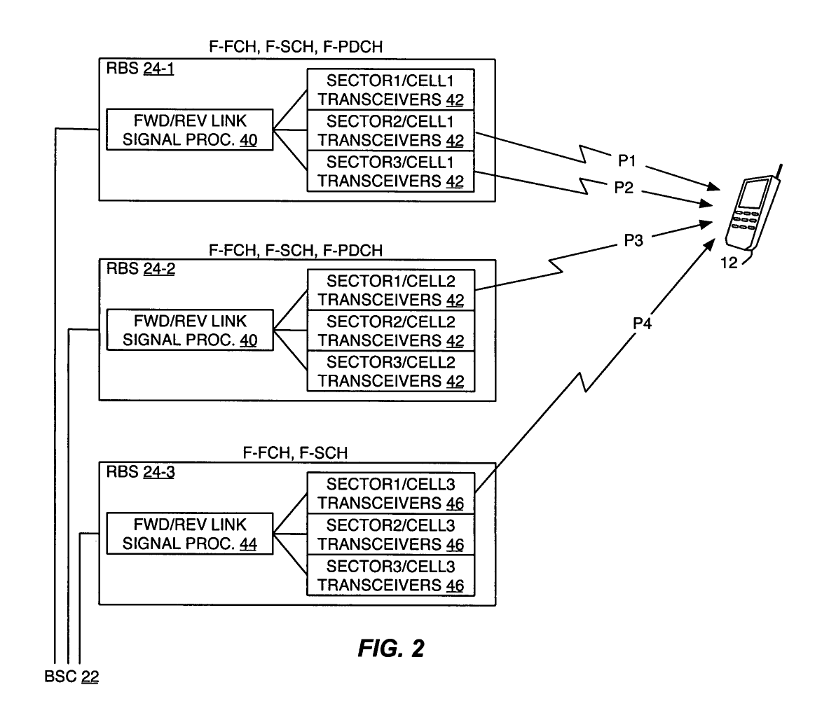

FIG. 2 illustrates an example of the above described mix of RBS capabilities, wherein the mobile station 12 receives pilot signals (P1, P2, P3, and P4) from RBSs 24-1, 24-2, and 24-3 of sufficient strength to be included in the mobile station's complete active set. In this context, the complete active set of RBSs 24 are those that provide a pilot signal to the mobile station 12 at or above a defined signal strength threshold, without regard to whether the individual RBSs 24 in the complete active set offer shared channel packet data service on the F-PDCH.

The RBSs 24-1 and 24-2 provide dedicated channel packet data service via F-FCH and F-SCH transmissions, and provide shared channel packet data service via F-PDCH transmissions, and each one comprises forward/reverse link signal processing circuits 40 and sectorized radio transceivers 42. By way of non-limiting example, three sectors are illustrated. The RBS 24-3 lacks F-PDCH capability and thus provides packet data services via F-FCH and F-SCH transmissions, and comprises forward/reverse link signal processing circuits 44 and sectorized radio transceivers 46.

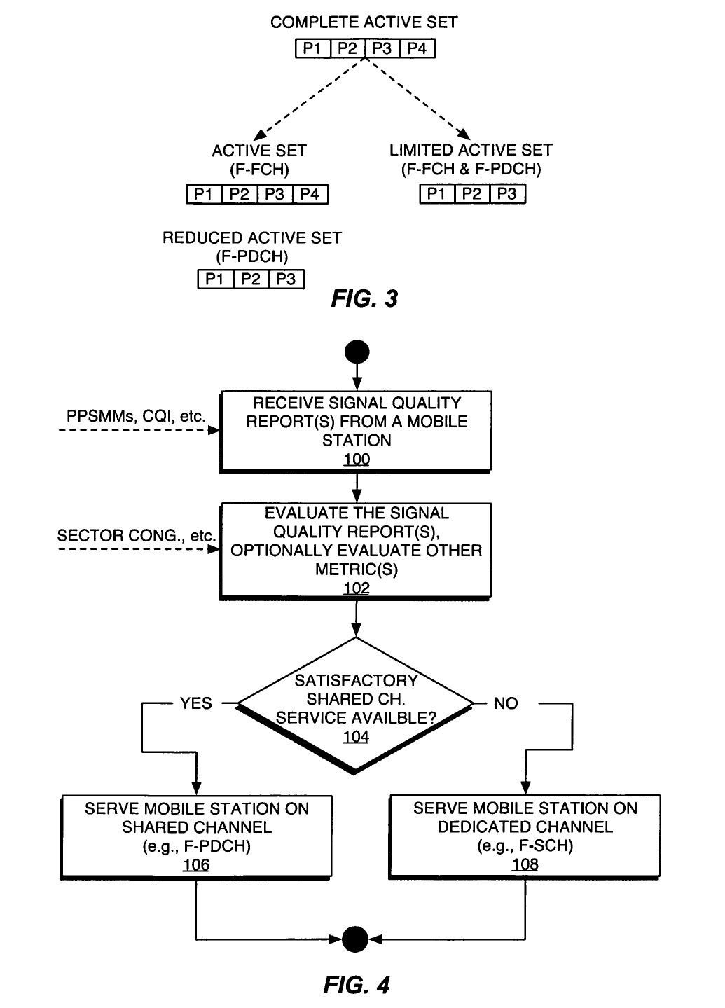

Thus, in one or more embodiments of active set management, a given mobile station's complete active set—which changes with changing reception condition—provides the starting point for set management. FIG. 3 illustrates the complete active set for the mobile station 12 shown in FIG. 2, wherein the complete active set comprises pilots P1, P2, P3, and P4, corresponding, respectively, to SECTOR2/CELL1 (RBS 24-1), SECTOR3/CELL1 (RBS 24-1), SECTOR1/CELL2 (RBS 24-2), and SECTOR1/CELL3 (RBS 24-3). Of these pilots, P1, P2, and P3 correspond to radio base stations having F-PDCH capability. Pilot P4 corresponds to a radio base station lacking F-PDCH capability. Thus, one type of radio base station capable of providing a sufficiently strong radio link to the mobile station 12 lacks shared channel capability, while another type of radio base station also capable of providing a sufficiently strong radio link to the mobile station provides that capability.

In one method of active set management, the complete active set is used for non-packet, circuit-switched services (e.g., voice, fax, etc.). Since these services use FCHs, at least in cdma2000 embodiments, the complete active set is used to support communications based on FCH transmissions (forward and reverse) between the mobile station 12 and the involved RBSs 24. A subset of the complete active set, referred to as a reduced active set, is used to support high-rate packet data services on the F-PDCH in cdma2000 embodiments—other embodiments may use a different shared channel, such as the HSDPA in W-CDMA. Thus, FIG. 3 illustrates the reduced active set as comprising pilots P1, P2, and P3, but not P4 because it is associated with RBS 24-3, which lacks F-PDCH capability.

Alternatively, rather than using one set for FCH services and another set for PDCH services, another embodiment of active set management constrains the working active set of a given mobile station 12 for all services to its reduced active set. This constrained set of RBSs 24 is referred to as the limited active set of the mobile station. The advantage of using a limited active set is the simplification gained by maintaining one active set for the mobile station 12, rather than two. However, the disadvantage is that the mobile station 12 uses less than its complete active set for FCH services if one or more of the RBSs 24 in its complete active set lacks PDCH capabilities.

Regardless of whether the network 10 implements reduced active set or limited active set controls, FIG. 4 illustrates a method of selectively serving a given mobile station 12 using a shared or a dedicated packet data channel based on evaluating signal quality reports received from the mobile station 12, which may include signal strength or quality measurements for every pilot signal in the mobile station's complete active set (Steps 100 and 102). Non-limiting examples of the types of signal quality reports received by the network 10 from the mobile station 12 include Periodic Pilot Strength Measurement Messages (PSMMs), Channel Quality Indicator (CQI) Reports, and the like. In particular, PSMMs sent periodically or otherwise provide the network 10 with the means to evaluate the received signal strength of each pilot signal in the mobile station's complete active set.

The evaluation of those reported pilot strengths provides one basis for determining whether satisfactory shared channel service is available for the mobile station 12 (Step 104). If satisfactory shared channel packet data service is available, the mobile station 12 is served on a shared packet data channel (Step 106), e.g., the F-PDCH, from a selected RBS 24. Conversely, if shared channel packet data service is not available, the mobile station 12 is served using a dedicated packet data channel (Step 108), e.g., a SCH.

In addition simply to evaluating reported pilot strengths to determine whether any PDCH-capable RBS 24 will provide satisfactory signal strength to the mobile station 12, the network 10 can be configured to evaluate additional service metrics to determine whether or not the mobile station 12 should be assigned to a shared or a dedicated channel. For example, if pilot signal in the PSMM corresponds to a PDCH-capable RBS 24, the network 10 might further consider network loading/congestion conditions at that RBS 24, or at the other RBSs 24 in the mobile station's complete active set. For example, even if a PDCH-capable RBS 24 is in the mobile station's complete active set, the mobile station 12 may not be assigned to the F-PDCH at that RBS 24 if a loading report or other message from that RBS 24 indicates that its forward and/or reverse links are heavily loaded, or that one or more of its transmission/communication resources are close to exhaustion.

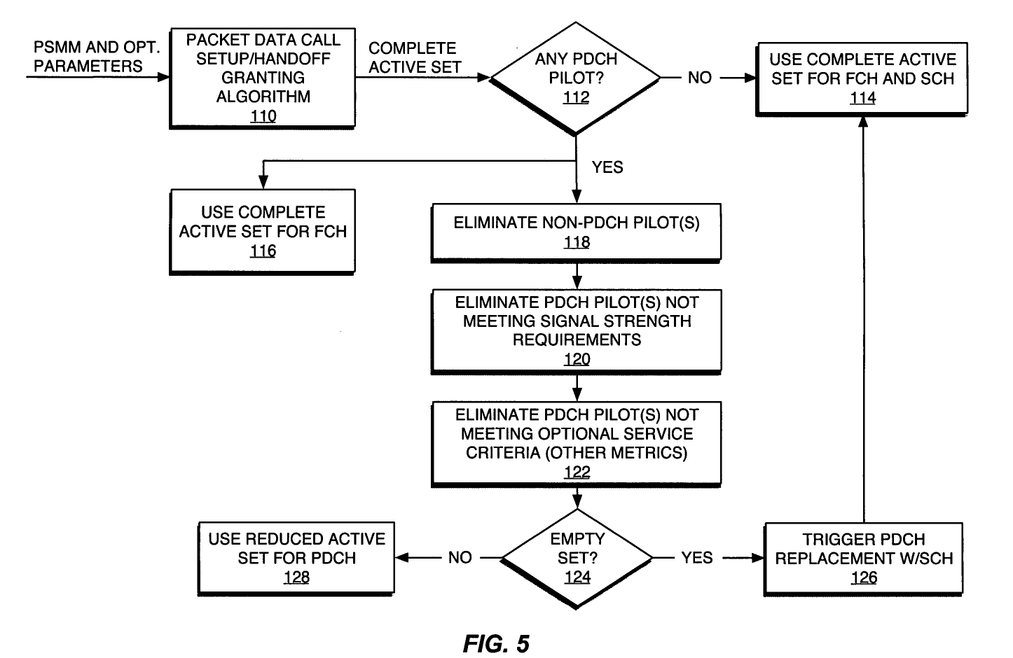

FIG. 5 places the above processing logic in the specific context of active set management based on the use of two active sets for a given mobile station 12: the complete active set or RBSs 24 for supporting voice and low-rate data services using FCHs, and a reduced active set of PDCH-capable RBSs 24 that form a subset of the complete active set for supporting high-rate, PDCH-based packet data services. Processing begins with PSMM information and additional, optional parameter information (e.g., sector loading information) being provided to a packet data call handoff granting algorithm (Step 110). The complete active set of RBSs 24 is evaluated to determine whether there are any pilots in it corresponding to PDCH-capable RBSs 24 (Step 112). If not, the network 10 uses the mobile station's complete active set to support FCH-based and SCH-based communications with the mobile station 12, meaning that higher-rate packet data services will be provided to the mobile station 12 using SCHs.

On the other hand, if there are any pilots in the complete active set corresponding to PDCH-capable RBSs 24, the network 10 uses that complete active set for supporting FCH-based communications (Step 116), but goes on to evaluate additional considerations for PDCH-based communications. More particularly, the network 10 carries out reduced active set processing by eliminating any non-PDCH pilots from the mobile station's complete active set (Step 118), and then eliminating any of the remaining PDCH-capable pilots that do not meet one or more defined signal strength requirements (Step 120). Optionally, the network 10 further eliminates any remaining PDCH-capable pilots that do not meet one or more other service criteria (Step 122). For example, a PDCH-capable pilot may be eliminated based on one or more additional evaluations—i.e., the RBS sector corresponding to that pilot signal is eliminated from consideration for use in supporting PDCH communications with the mobile station 12.

Thus, a PDCH-capable pilot may be eliminated if its corresponding RBS sector has too few resources currently available, such as too little available transmit power, or too few spreading code resources, or where PDCH handoff between base stations is not supported. In other words, a PDCH-capable pilot may be eliminated from the mobile station's reduced active set if the RBS sector corresponding to that pilot currently is not a good candidate for providing PDCH service to the mobile station 12, or is unavailable in handoff for PDCH service. Generally, a RBS sector is not a good candidate if that sector's F-PDCH already is heavily loaded, or if there are a large number of circuit-switched voice users in the sector, etc.

If the elimination of PDCH-capable pilots produces an empty reduced active set (Step 124), then the network 10 triggers replacement or substitution of the PDCH-based packet data service with SCH-based packet data service (Step 126). If the reduced active set is not an empty set, then the reduced active set is used to support PDCH-based communications and the mobile station 12 operates with one active set for FCH-based communications and another (reduced) active set for PDCH-based communications.

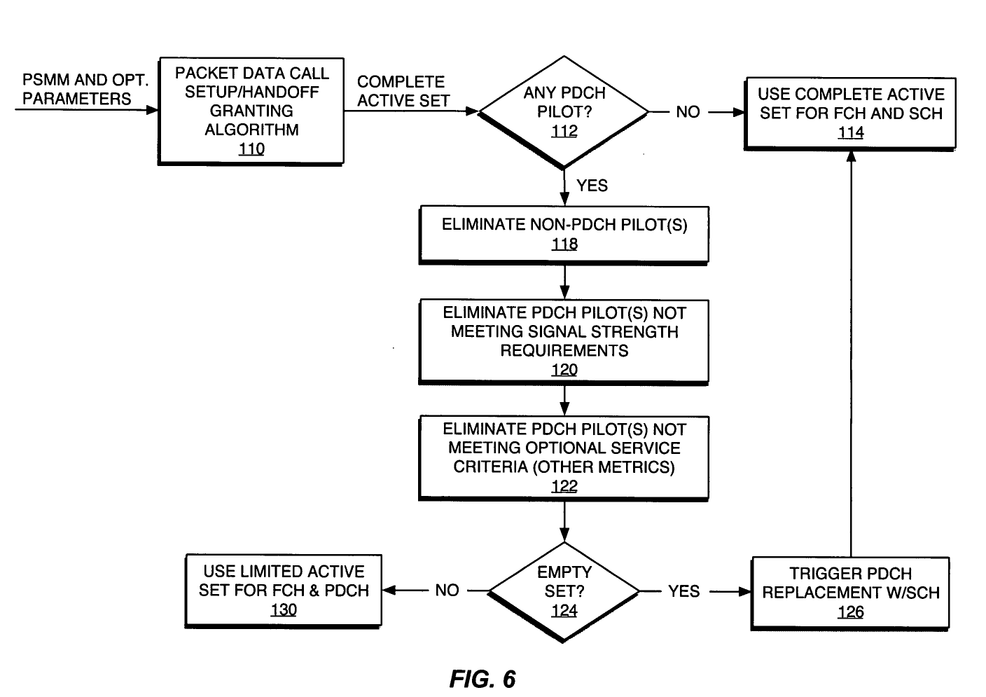

FIG. 6 illustrates similar processing but in the context of limited active sets, where the mobile station's active set for FCH-based communications is constrained to those RBSs 24 that can satisfactorily provide PDCH-based communications for the mobile station 24. Simply put, the mobile station 12 operates with one active set that generally is determined using the same criteria as used for determining the reduced active set in FIG. 5. Thus, processing in FIG. 6 differs from that of FIG. 5 at Step 130, wherein the reduced active set determined from Steps 118-122 is used as a limited active set for both FCH-based and PDCH-based communications with the mobile station 12.

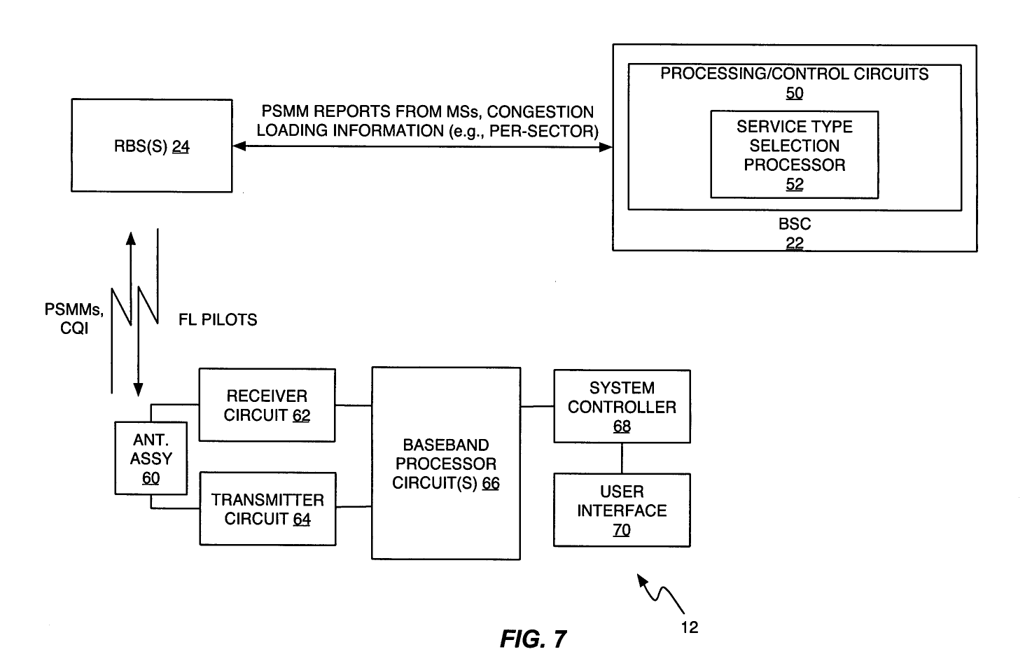

Whether complete and reduced active sets are used together, or a limited active set is used by itself, the active set management methods described above can be carried out by the BSC 22 illustrated in FIG. 7. The illustrated BSC 22 comprises processing/control circuits 50, which include a service type selection processor 52 that may comprise one or more microprocessor circuits, digital signal processing circuits, or other appropriately configured logic circuit.

Processor 52 thus may be implemented in hardware, software, or any combination thereof. In at least one embodiment, the processor 52 comprises one or more microprocessor circuits executing program instructions that implement one or more embodiments of the shared/dedicated channel service type selection methods based on active set management as variously described in the context of FIGS. 4-6.

Thus, BSC 22 can be configured for operation in essentially any type of wireless communication network having radio base stations of a first type that support dedicated packet data channel service and one or more radio base stations of a second type that additionally support shared packet data channel service. In this role, the service type selection processor 52 of BSC 22 can be configured to receive one or more signal quality reports from a given mobile station 12, and determine whether to serve the mobile station 12 on a shared packet data channel or on a dedicated packet data channel based on evaluating the one or more signal quality reports. In a non-limiting example, the wireless communication network comprises a cdma2000-based wireless communication network wherein the first type of radio base stations comprise 1× Radio Transmission Technology (1×RTT) radio base stations, and wherein the second type of radio base stations comprise 1× Evolution Data and Voice (1×EV-DV) radio base stations.

In operation, the processing circuit(s) comprising the service type selection processor 52 are configured to receive a pilot strength measurement report for a complete active set of a given mobile station 12, and to determine whether to serve the mobile station 12 on a shared packet data channel or on a dedicated packet data channel by determining whether the pilot strength measurement report indicates the availability of satisfactory shared packet data channel service to the mobile station 12. For example, processor 52 determines whether any pilots in the signal strength report correspond to PDCH-capable base stations and, optionally, determines whether any such pilots have sufficient signal strength, whether the corresponding RBSs 24 are too heavily loaded, etc. Signal quality strength information received from the mobile station 12 via the RBSs 24 and loading/congestion information from the RBSs 24 can be provided to the BSC 22 via its communication links with the RBSs 24, or indirectly through its links with other network entites.

Although not critical to understanding active set management, FIG. 7 further illustrates an embodiment of a mobile station 12 that comprises an antenna assembly 60, a receiver circuit 62, a transmitter circuit 64, a baseband processor circuit 66, a system controller 68, and a user interface 70, which may comprise a display, keypad, audio input/output devices, etc., depending on the intended use and features of the mobile station 12.

Regardless of its construction details, the mobile station 12 receives pilot signals from one or more RBSs 24. In one or more embodiments, the mobile station 12 has a set of pilots corresponding to FCH service, and a set of pilots corresponding to FPDCH service. The pilots to be associated with the different service/channel types may be identified to the mobile station 12 by the network 10. In at least one embodiment, the network 10 identifies the mobile station's complete active set and the mobile station 12 makes signal strength measurements for the corresponding pilot signals and returns those measurements to the network 10.

Of course, the present invention is not limited to any particular mobile station architecture, nor to any particular BSC architecture. Indeed, the present invention broadly contemplates managing the active sets of radio base stations for providing packet data services to mobile stations using either shared or dedicated channels, depending on the mix of shared or dedicated channel capabilities of the RBSs in the mobile station's complete active set and, optionally, depending on the consideration of other network conditions, such as the levels of forward and/or reverse link loading in the associated radio sectors. As such, the present invention is limited only by the following claims and their legal equivalents.

What is claimed is:

1. A method of managing packet data service to a mobile station in a wireless communication network comprising one or more radio base stations of a first type that support dedicated packet data channel service and one or more radio base stations of a second type that support shared packet data channel service, the method comprising:
receiving and evaluating one or more signal quality reports from the mobile station; and
serving the mobile station on a shared packet data channel if the one or more signal quality reports indicate the availability of satisfactory shared packet data channel service to the mobile station, and otherwise serving the mobile station on a dedicated packet data channel.

2. The method of claim 1, wherein the wireless communication network comprises a cdma2000-based wireless communication network wherein the first type of radio base stations comprise 1× Radio Transmission Technology (lxRTT) radio base stations, and wherein the second type of radio base stations comprise 1× Evolution Data and Voice (1×EV-DV) radio base stations.

3. The method of claim 1, wherein receiving and evaluating one or more signal quality reports from the mobile station comprises receiving one or more pilot strength measurement reports from the mobile station.

4. The method of claim 3, wherein receiving and evaluating one or more signal quality reports from the mobile station comprises receiving a pilot strength measurement report for a complete active set of the mobile station, determining whether any pilot signal in the complete active set corresponds to a radio base station of the second type and meets one or more defined service criteria and, if so, serving the mobile station on a shared packet data channel and otherwise serving the mobile station on a dedicated packet data channel.

5. The method of claim 1, wherein receiving and evaluating one or more signal quality reports from the mobile station comprises receiving a pilot strength report from the mobile station identifying an active set of radio base stations comprising first and second types of radio base stations, determining whether any pilot signal in the pilot strength report corresponds to a radio base station of the second type and meets one or more service criteria and, if so, serving the mobile station on a shared packet data channel and, otherwise, serving the mobile station on a dedicated packet data channel.

6. The method of claim 5, further comprising defining a first active set for the mobile station comprising radio base stations to be used for providing fundamental channel service to the mobile station and defining a reduced active set for the mobile station comprising radio base stations to be used for providing shared packet data channel service to the mobile station.

7. The method of claim 5, wherein the second type of radio base stations support both dedicated packet data channel service and shared packet data channel service, and further comprising defining a limited active set for the mobile station by constraining those radio base stations to be used for providing fundamental channel service to the mobile station to be the same ones used for providing shared packet data channel service to the mobile station.

8. A base station controller for use in a wireless communication network having radio base stations of a first type that support dedicated packet data channel service and one or more radio base stations of a second type that support shared packet data channel service, said base station controller comprising one or more processing circuits configured to: receive one or more signal quality reports from the mobile station; and
determine whether to serve the mobile station on a shared packet data channel or on a dedicated packet data channel based on evaluating the one or more signal quality reports.

9. The base station controller of claim 8, wherein the wireless communication network comprises a cdma2000-based wireless communication network wherein the first type of radio base stations comprise 1× Radio Transmission Technology (1×RTT) radio base stations, and wherein the second type of radio base stations comprise 1× Evolution Data and Voice (1×EV-DV) radio base stations.

10. The base station controller of claim 8, wherein the one or more processing circuits are configured to receive a pilot strength measurement report for a complete active set of the mobile station as the one or more signal quality reports from the mobile station.

11. The base station controller of claim 10, wherein the one or more processing circuits are configured to determine whether to serve the mobile station on a shared packet data channel or on a dedicated packet data channel by determining whether pilot strength measurement report indicates the availability of satisfactory shared packet data channel service to the mobile station.

12. The base station controller of claim 10, wherein the one or more processing circuits are configured to determine whether to serve the mobile station on a shared packet data channel or on a dedicated packet data channel by determining whether any pilot signal in the complete active set corresponds to a radio base station of the second type and meets one or more defined service criteria and, if so, serving the mobile station on a shared packet data channel and otherwise serving the mobile station on a dedicated packet data channel.

13. The base station controller of claim 8, wherein the one or more processing circuits are configured to receive a pilot strength report from the mobile station identifying an active set of radio base stations comprising first and second types of radio base stations, to determine whether any pilot signal in the pilot strength report corresponds to a radio base station of the second type and meets one or more service criteria and, if so, to serve the mobile station on a shared packet data channel and, if not, to serve the mobile station on a dedicated packet data channel.

14. The base station controller of claim 13, wherein the one or more processing circuits are further configured to define a first active set for the mobile station comprising radio base stations to be used for providing fundamental channel service to the mobile station and defining a reduced active set for the mobile station comprising radio base stations to be used for providing shared packet data channel service to the mobile station.

15. The base station controller of claim 13, wherein the second type of radio base stations support both dedicated packet data channel service and shared packet data channel service, and wherein the one or more processing circuits are further configured to define a limited active set for the mobile station by constraining those radio base stations to be used for providing fundamental channel service to the mobile station to be the same ones used for providing shared packet data channel service to the mobile station.

16. A method of determining whether to serve a mobile station on a shared packet data channel or on a dedicated packet data channel in a wireless communication network comprising radio base stations of a first type supporting dedicated packet data channel service and radio base stations of a second type supporting shared packet data channel service, the method comprising:
receiving a pilot strength measurement report from the mobile station;
if any pilot signals in the pilot strength measurement report correspond to radio base stations of the second type, selectively serving the mobile station on a shared packet data channel or on a dedicated packet data channel based on determining whether more service criteria are met; and
if no pilot signals in the pilot strength measurement report correspond to radio base stations of the second type, serving the mobile station on a dedicated packet data channel.

17. The method of claim 16, wherein the wireless communication network comprises a cdma2000-based wireless communication network, and wherein serving the mobile station on a shared packet data channel comprises serving the mobile station on a Forward Packet Data Channel (F-PDCH), and serving the mobile station on a dedicated packet data channel comprises serving the mobile station on a Forward Supplemental Channel (F-SCH).

18. The method of claim 16, wherein selectively serving the mobile station on a shared packet data channel or on a dedicated packet data channel based on determining whether more service criteria are met comprises serving the mobile station on a shared packet data channel if a defined number of the pilot signals in the pilot strength measurement report that correspond to radio base stations of the second type exceed a defined signal strength threshold and otherwise serving the mobile station on a dedicated packet data channel.

19. The method of claim 16, wherein selectively serving the mobile station on a shared packet data channel or on a dedicated packet data channel based on determining whether more service criteria are met comprises serving the mobile station on a shared packet data channel if a defined number of the pilot signals in the pilot strength measurement report that correspond to radio base stations of the second type exceed a defined signal strength threshold and radio base station loading levels at the corresponding radio base stations are below one or more defined loading thresholds, and otherwise serving the mobile station on a dedicated packet data channel.
